(19) United States
(12) Patent Application Publication
(10) Pub. No.: US 2026/0213810 A1
(43) Pub. Date: Jul. 23, 2026

(54) STATE DETECTION SYSTEM, DETECTION DEVICE, STATE DETECTION METHOD AND STATE DETECTION PROGRAM

(71) Applicant: NTT, Inc., Tokyo (JP)

(72) Inventors: Keita KURIYAMA, Musashino-shi, Tokyo (JP); Toshifumi MIYAGI, Musashino-shi, Tokyo (JP)

(73) Assignee: NTT, Inc., Tokyo (JP)

(21) Appl. No.: 19/143,471

(22) PCT Filed: Jan. 10, 2023
(86) PCT No.: PCT/JP2023/000340

§ 371 Date: Jun. 26, 2025

(51) Int. Cl. H04B 7/06

(52) U.S. Cl. CPC H04B 7/0626

(57) ABSTRACT

A state detection system according to one embodiment is a state detection system including: a transmission device that transmits a predetermined signal; and a detection device, wherein the detection device includes: a receiver to receive, via the propagation path, a radio frame a part of which includes a known signal sequence and that is repeatedly transmitted; extraction circuitry configured to extract correspondence signals corresponding to the known signal sequence from the radio frame received; correlation signal calculation circuitry configured to calculate correlation signals indicating correlations between the correspondence signals extracted and the known signal sequence; time correlation calculation circuitry configured to calculate a time correlation between the correlation signals calculated; and determination circuitry configured to determine that the object is in a stationary state in a case where the time correlation calculated is equal to or greater than a predetermined threshold value.

### TECHNICAL FIELD

The present invention relates to a state detection system, a detection device, a state detection method, and a state detection program.

### BACKGROUND ART

Conventionally, a sensing technology for detecting an object by using channel state information (CSI) of a wireless LAN has been studied.

For example, Patent Literature 1 discloses an object detection system using channel state information of a wireless LAN, which is capable of detecting a moving direction of an object even in an environment in which there are many changes in a radio propagation environment other than the detection target and there are few multipaths.

### CITATION LIST

### Patent Literature

Patent Literature 1: JP 2022-20515 A

### SUMMARY OF INVENTION

### Technical Problem

However, in a case where an object is detected by use of CSI, detection accuracy largely depends on an arrangement of antennas and a surrounding propagation environment. Therefore, a system design considering the influence of radio wave propagation characteristics on the object detection accuracy is required.

In addition, conventionally, there is also a problem that prior learning for performing detection is required when an object is detected by use of CSI.

The present invention has been made in view of the above-described problems, and an object of the present invention is to provide a state detection system, a detection device, a state detection method, and a state detection program capable of accurately detecting a state of an object even if learning is not performed in advance.

### Solution to Problem

A state detection system according to one embodiment of the present invention is a state detection system including: a transmission device that transmits a predetermined signal; and a detection device that detects a state of an object on a propagation path of the signal transmitted by the transmission device, wherein the detection device includes: a reception unit that receives, via the propagation path, a radio frame a part of which includes a known signal sequence and that is repeatedly transmitted by the transmission device; an extraction unit that extracts correspondence signals corresponding to the known signal sequence from the radio frame received by the reception unit; a correlation signal calculation unit that calculates correlation signals indicating correlations between the correspondence signals extracted by the extraction unit and the known signal sequence; a time correlation calculation unit that calculates a time correlation between the correlation signals calculated by the correlation signal calculation unit; and a determination unit that determines that the object is in a stationary state in a case where the time correlation calculated by the time correlation calculation unit is equal to or greater than a predetermined threshold value.

In addition, a detection device according to one embodiment of the present invention includes: a reception unit that receives a radio frame a part of which includes a known signal sequence and that is repeatedly transmitted by a transmission device via a propagation path of the radio frame transmitted by the transmission device; an extraction unit that extracts correspondence signals corresponding to the known signal sequence from the radio frame received by the reception unit; a correlation signal calculation unit that calculates correlation signals indicating correlations between the correspondence signals extracted by the extraction unit and the known signal sequence; a time correlation calculation unit that calculates a time correlation between the correlation signals calculated by the correlation signal calculation unit; and a determination unit that determines that an object on the propagation path is in a stationary state in a case where the time correlation calculated by the time correlation calculation unit is equal to or greater than a predetermined threshold value.

In addition, a state detection method according to one embodiment of the present invention is a state detection method for detecting a state of an object on a propagation path of a signal transmitted by a transmission device that transmits a predetermined signal, the state detection method including: a reception step of receiving, via the propagation path, a radio frame a part of which includes a known signal sequence and that is repeatedly transmitted by the transmission device; an extraction step of extracting correspondence signals corresponding to the known signal sequence from the radio frame received in the reception step; a correlation signal calculation step of calculating correlation signals indicating correlations between the correspondence signals extracted in the extraction step and the known signal sequence; a time correlation calculation step of calculating a time correlation between the correlation signals calculated in the correlation signal calculation step; and a determination step of determining that the object is in a stationary state in a case where the time correlation calculated in the time correlation calculation step is equal to or greater than a predetermined threshold value.

### Advantageous Effects of Invention

According to the present invention, it is possible to accurately detect a state of an object even if learning is not performed in advance.

### BRIEF DESCRIPTION OF DRAWINGS

FIG. 1 is a diagram illustrating an outline of a state detection system according to one embodiment.

FIG. 2 is a functional block diagram illustrating functions of a detection device according to the one embodiment.

FIG. 3(a) is a diagram illustrating a radio frame a part of which includes a known signal sequence and that is repeatedly transmitted by a transmission device. FIG. 3(b) is a diagram schematically illustrating correlation signals calculated by a correlation signal calculation unit. FIG. 3(c) is a diagram schematically illustrating time correlations calculated by a time correlation calculation unit.

FIG. 4 is a diagram illustrating an exemplary hardware configuration of the detection device according to the one embodiment.

FIG. 5(a) is a diagram schematically illustrating a result of detection by the state detection system, which indicates that a person in a house is in a moving state.

FIG. 5(b) is a diagram schematically illustrating a result of detection by the state detection system, which indicates that a person in the house is in a stationary state.

### DESCRIPTION OF EMBODIMENTS

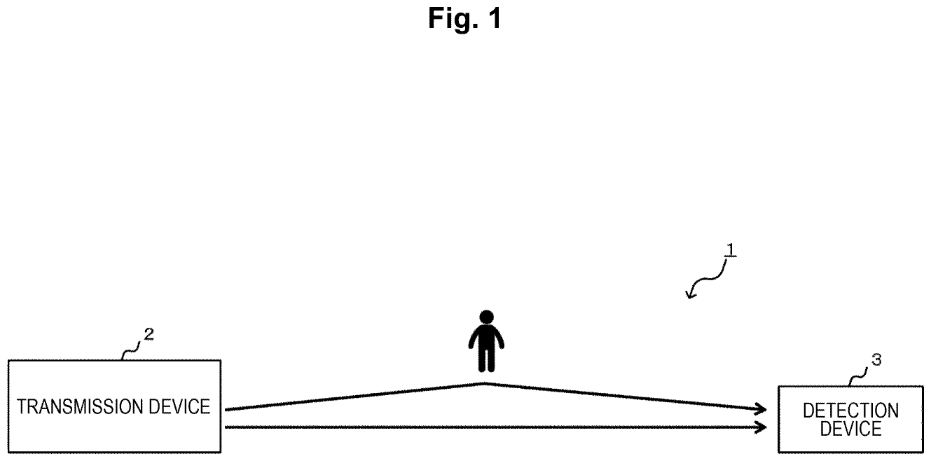

Hereinafter, a state detection system 1 according to one embodiment will be described with reference to the drawings. FIG. 1 is a diagram illustrating an outline of the state detection system 1 according to the one embodiment.

As illustrated in FIG. 1, the state detection system 1 according to the one embodiment includes, for example, a transmission device 2 that transmits a predetermined signal and a detection device 3 that detects a state of an object on a propagation path of the signal transmitted by the transmission device 2.

The transmission device 2 is a communication device used for, for example, local 5G, Wi-Fi (registered trademark), Bluetooth (registered trademark), and other wireless systems, and the type and frequency of the system may be any type and frequency.

The detection device 3 has a function of receiving a radio wave transmitted by the transmission device 2, and may be, for example, a soft wireless device having a function of observing a waveform of a received radio wave, a function of analyzing an observed waveform, and the like.

Here, objects whose states are detected by the state detection system 1 include a person and the like. The state detection system 1 is configured to be able to detect whether a person is in a moving state (moving state) or a person is in a stationary state (stationary state).

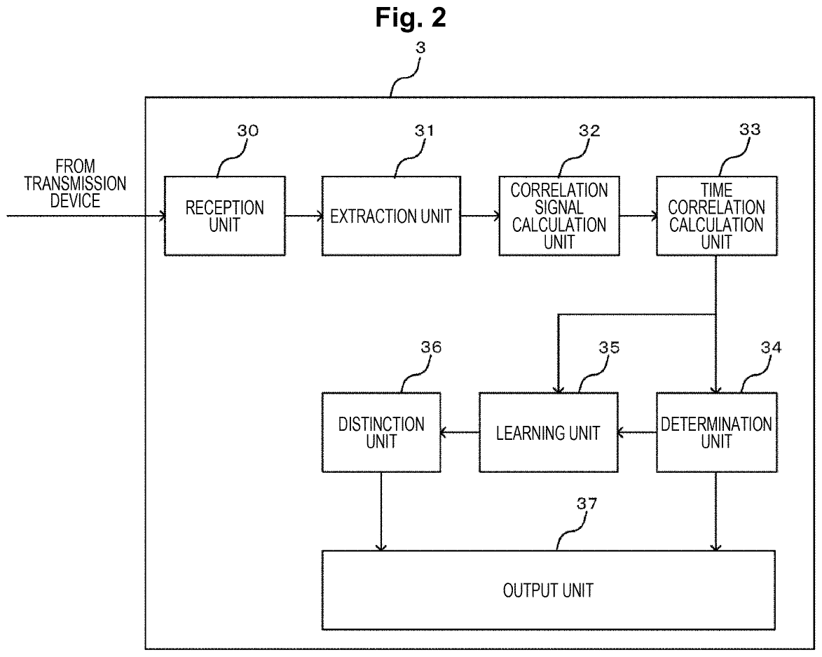

Next, a specific example of the functions of the detection device 3 will be described. FIG. 2 is a functional block diagram illustrating the functions of the detection device 3 according to the one embodiment. As illustrated in FIG. 2, the detection device 3 includes, for example, a reception unit 30, an extraction unit 31, a correlation signal calculation unit 32, a time correlation calculation unit 33, a determination unit 34, a learning unit 35, a distinction unit 36, and an output unit 37.

The reception unit 30 receives a radio frame a part of which includes a known signal sequence and that is repeatedly transmitted by the transmission device 2 via a propagation path of a signal transmitted by the transmission device 2, and outputs the radio frame to the extraction unit 31. Note that the length of the known signal sequence is set to be longer than the maximum delay wavelength in the propagation path of the signal transmitted by the transmission device 2. In addition, the signal sequence of the signal transmitted by the transmission device 2 may be unknown as long as a repetition period is known.

The extraction unit 31 extracts correspondence signals corresponding to the known signal sequence of the signal transmitted by the transmission device 2 from the radio frame received by the reception unit 30, and outputs the correspondence signals to the correlation signal calculation unit 32. For example, the extraction unit 31 sequentially slides the known signal sequence with respect to the received signal (the signal transmitted by the transmission device 2) to extract correspondence signals corresponding to the known signal sequence. More specifically, since a peak occurs in the radio wave signal at a constant period at which the reception unit 30 receives the known signal sequence, the extraction unit 31 extracts a correspondence signal of the known signal portion where the peak occurs.

The correlation signal calculation unit 32 calculates correlation signals (correlation outputs) indicating correlations between the correspondence signals extracted by the extraction unit 31 and the known signal sequence of the signal transmitted by the transmission device 2, and outputs the correlation signals to the time correlation calculation unit 33.

The time correlation calculation unit 33 calculates a time correlation between the correlation signals calculated by the correlation signal calculation unit 32, and outputs the time correlation to the determination unit 34 and the learning unit 35.

The determination unit 34 determines that an object on the propagation path of the signal transmitted by the transmission device 2 is in the stationary state in a case where the time correlation calculated by the time correlation calculation unit 33 is equal to or greater than a predetermined threshold value. In addition, the determination unit 34 determines that the object on the propagation path of the signal transmitted by the transmission device 2 is in the moving state in a case where the time correlation calculated by the time correlation calculation unit 33 is smaller than the predetermined threshold value. The determination unit 34 then outputs a result of the determination to the learning unit 35 and the output unit 37.

The learning unit 35 learns the variation amount of the time correlation calculated by the time correlation calculation unit 33 and outputs a result of the learning to the distinction unit 36. For example, the learning unit 35 learns the level of the time correlation calculated by the time correlation calculation unit 33 and the variation amount of a delay spread.

The distinction unit 36 distinguishes whether a change in the state of the object on the propagation path of the signals transmitted by the transmission device 2 or a change in the environment on the propagation path has occurred on the basis of the variation amount learned by the learning unit 35, and outputs a result of the distinction to the output unit 37.

The output unit 37 is, for example, an alarm, a display, or the like that outputs sound or an image, and outputs the result of the determination by the determination unit 34, the result of the distinction by the distinction unit 36, and the like by sound, an image, or the like. Furthermore, the output unit 37 may be configured to output the result of the determination by the determination unit 34, the result of the distinction by the distinction unit 36, and the like by transmission through communication.

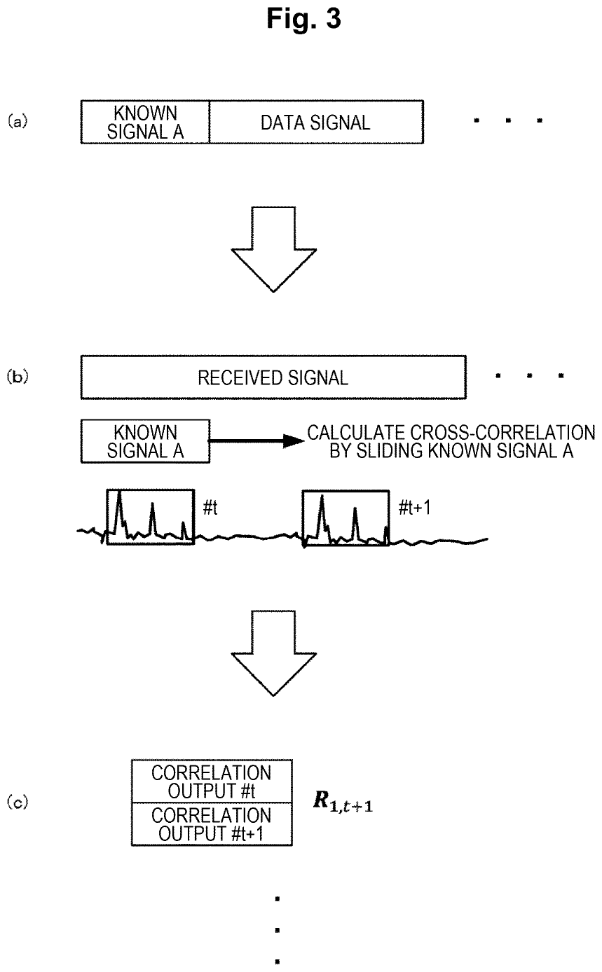

Next, exemplary processing executed by the state detection system 1 will be described. FIG. 3 is a diagram illustrating signals in each step of processing executed by the state detection system 1. FIG. 3(a) is a diagram illustrating a radio frame a part of which includes a known signal sequence (known signal A) and that is repeatedly transmitted by the transmission device 2. FIG. 3(b) is a diagram schematically illustrating correlation signals (correlation outputs #t and #t+1) calculated by the correlation signal calculation unit 32. FIG. 3(c) is a diagram schematically illustrating time correlations calculated by the time correlation calculation unit 33.

As illustrated in FIG. 3(a), the transmission device 2 repeatedly transmits a radio frame a part of which includes a known signal sequence. At this time, the length of the known signal sequence is set to be longer than the maximum delay wavelength in the propagation path of the signal transmitted by the transmission device 2.

As illustrated in FIG. 3(b), the correlation signal calculation unit 32 calculates correlation signals (correlation outputs #t and #t+1) each indicating a correlation between the known signal sequence of the signal transmitted by the transmission device 2 and one of correspondence signals extracted by the extraction unit 31 from the received signal received by the reception unit 30 by sequentially sliding the known signal sequence.

As illustrated in FIG. 3(c), the time correlation calculation unit 33 calculates a time correlation (R_{1, t+1}) between the correlation signals (correlation outputs #t and #t+1) calculated by the correlation signal calculation unit 32.

In a case where the time correlation (R_{1, t+1}) calculated by the time correlation calculation unit 33 is equal to or greater than a predetermined threshold value & (for example, R_{1, t+1}≥α), the determination unit 34 determines that an object on the propagation path of the signal transmitted by the transmission device 2 is in the stationary state. In addition, in a case where the time correlation (R_{1, t+1}) calculated by the time correlation calculation unit 33 is smaller than the predetermined threshold value a (for example, R_{1, t+1}<α), the determination unit 34 determines that the object on the propagation path of the signal transmitted by the transmission device 2 is in the moving state.

Note that the state detection system 1 may be configured to calculate a time correlation by extracting a known signal (for example, a control signal such as a synchronization signal or a channel estimation signal) inserted into a part of a general radio frame transmitted by the transmission device 2.

As described above, the state detection system 1 according to the one embodiment calculates correlation signals indicating correlations between correspondence signals extracted by the extraction unit 31 and a known signal sequence, calculates a time correlation between the calculated correlation signals, and determines that an object on the propagation path of the signal transmitted by the transmission device 2 is in the stationary state in a case where the time correlation is equal to or greater than a predetermined threshold value, so that it is possible to accurately detect a state of the object even if learning is not performed in advance.

Note that some or all of the functions of the transmission device 2 and the detection device 3 may be configured by hardware such as a programmable logic device (PLD) or a field programmable gate array (FPGA), or may be configured as a program executed by a processor such as a CPU.

For example, the detection device 3 can be implemented with a computer and a program, and the program can be recorded in a storage medium or provided through a network.

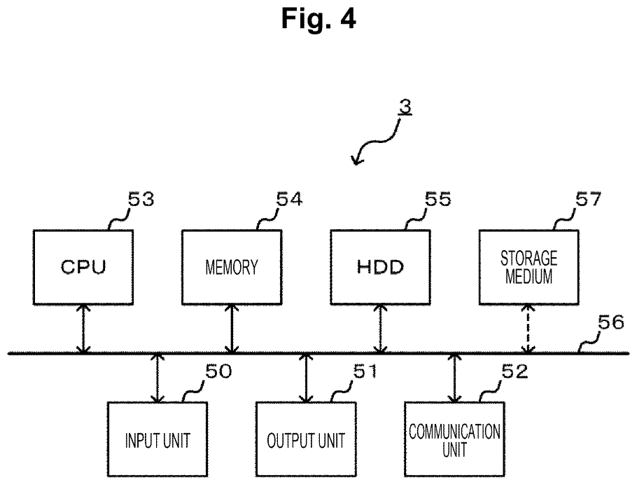

FIG. 4 is a diagram illustrating an exemplary hardware configuration of the detection device 3 according to the one embodiment. As illustrated in FIG. 4, the detection device 3 has a function as a computer in which an input unit 50, an output unit 51, a communication unit 52, a CPU 53, a memory 54, and an HDD 55 are connected via a bus 56. In addition, the detection device 3 can input and output data to and from a computer-readable storage medium 57.

The input unit 50 is, for example, a keyboard and a mouse or the like. The output unit 51 is, for example, a display device such as an alarm or a display corresponding to the output unit 37 described above. The communication unit 52 is a communication interface that performs wireless communication by, for example, a wireless LAN.

The CPU 53 controls each unit included in the detection device 3 and performs predetermined processing and the like. The memory 54 and the HDD 55 are storage units that store data and the like.

The storage medium 57 can store programs and the like for executing the functions of the detection device 3. Note that the architecture that configures the detection device 3 is not limited to the example illustrated in FIG. 4.

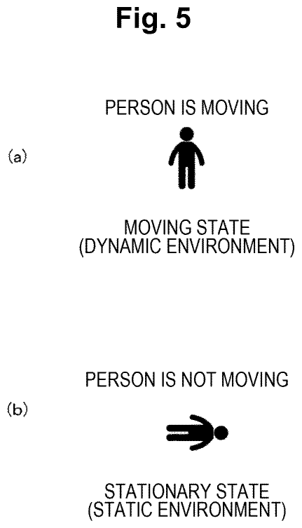

Next, a practical example of the state detection system 1 will be described. FIG. 5 is a diagram illustrating detection results obtained in a case where the state detection system 1 is installed in a house in which an elderly person or the like lives. FIG. 5(a) is a diagram schematically illustrating a result of detection by the state detection system 1, which indicates that a person in the house is in the moving state. FIG. 5(b) is a diagram schematically illustrating a result of detection by the state detection system 1, which indicates that a person in the house is in the stationary state.

In recent years, there have been social problems of the discrimination against the elderly and the like in which a lessor does not lease a house to a single household person such as an elderly person due to concerns about the solitary death or the like of the elderly person.

For example, in a case where the state detection system 1 is installed in a closed space (static fading environment) such as a house in which an elderly person or the like lives, it is possible to detect a state in which the person or the like is moving (dynamic environment) and a state in which the person or the like is stationary (static environment). For example, in a case where the person in the house continues the stationary state for a long time (in a case where the person stops moving), a propagation state of radio waves is different from that in a case where the person moves, and thus the state detection system 1 detects the state in which the person stops moving, and issues an alarm.

### REFERENCE SIGNS LIST

1 State detection system
2 Transmission device
3 Detection device
30 Reception unit
31 Extraction unit
32 Correlation signal calculation unit
33 Time correlation calculation unit
34 Determination unit
35 Learning unit
36 Distinction unit
37 Output unit
50 Input unit
51 Output unit
52 Communication unit
53 CPU
54 Memory
55 HDD
56 Bus
57 Storage medium

1. A state detection system comprising: a transmission device that transmits a predetermined signal; and a detection device that detects a state of an object on a propagation path of the signal transmitted by the transmission device, wherein
the detection device includes:
a receiver to receive, via the propagation path, a radio frame a part of which includes a known signal sequence and that is repeatedly transmitted by the transmission device;
extraction circuitry configured to extract correspondence signals corresponding to the known signal sequence from the radio frame received by the receiver;
correlation signal calculation circuitry configured to calculate correlation signals indicating correlations between the correspondence signals extracted by the extraction circuitry and the known signal sequence;
time correlation calculation circuitry configured to calculate a time correlation between the correlation signals calculated by the correlation signal calculation circuitry; and
determination circuitry configured to determine that the object is in a stationary state in a case where the time correlation calculated by the time correlation calculation circuitry is equal to or greater than a predetermined threshold value.

2. The state detection system according to claim 1, wherein
a length of the known signal sequence
is longer than a maximum delay wavelength in the propagation path.

3. The state detection system according to claim 1, further comprising:
learning circuitry configured to learn a variation amount of the time correlation calculated by the time correlation calculation circuitry; and
distinction circuitry configured to distinguish between a change in the state of the object and a change in an environment on the propagation path on a basis of the variation amount learned by the learning circuitry.

4. A detection device comprising:
a receiver to receive a radio frame a part of which includes a known signal sequence and that is repeatedly transmitted by a transmission device via a propagation path of the radio frame transmitted by the transmission device;
extraction circuitry configured to extract correspondence signals corresponding to the known signal sequence from the radio frame received by the receiver;
correlation signal calculation circuitry configured to calculate correlation signals indicating correlations between the correspondence signals extracted by the extraction circuitry and the known signal sequence;
time correlation calculation circuitry configured to calculate a time correlation between the correlation signals calculated by the correlation signal calculation circuitry; and
determination circuitry configured to determine that an object on the propagation path is in a stationary state in a case where the time correlation calculated by the time correlation calculation circuitry is equal to or greater than a predetermined threshold value.

5. The detection device according to claim 4, wherein
a length of the known signal sequence
is longer than a maximum delay wavelength in the propagation path.

6. The detection device according to claim 4, further comprising:
learning circuitry configured to learn a variation amount of the time correlation calculated by the time correlation calculation; and
distinction circuitry configured to distinguish between a change in the state of the object and a change in an environment on the propagation path on a basis of the variation amount learned by the learning circuitry.

7. A state detection method for detecting a state of an object on a propagation path of a signal transmitted by a transmission device that transmits a predetermined signal, the state detection method comprising:
receiving, via the propagation path, a radio frame a part of which includes a known signal sequence and that is repeatedly transmitted by the transmission device;
extracting correspondence signals corresponding to the known signal sequence from the radio frame received in receiving;
calculating correlation signals indicating correlations between the correspondence signals extracted in extracting and the known signal sequence;
calculating a time correlation between the correlation signals calculated step; and
determining that the object is in a stationary state in a case where the time correlation calculated is equal to or greater than a predetermined threshold value.

8. A non-transitory computer-readable storage medium storing a state detection program for causing a computer to function as each circuitry of the detection device according to claim 4.
